(19) United States
(12) Patent Application Publication
(10) Pub. No.: US 2020/0074101 A1
(43) Pub. Date: Mar. 5, 2020

(54) DE-IDENTIFICATION OF PROTECTED INFORMATION IN MULTIPLE MODALITIES

(71) Applicant: KONINKLIJKE PHILIPS N.V., EINDHOVEN (NL)

(72) Inventors: Eric Thomas Carlson, New York, NY (US); Mohammad Shahed Sorower, Natick, MA (US); Sreramkumar Sitaraman Viswanathan, Bangalore (IN); Manakkaparambil Sivanandan Sreekanth, Bangalore (IN); Anshul Jain, Bangalore (IN); Sunil Ranjan Khuntia, Bangalore (IN); Ze He, Cambridge, MA (US)

(21) Appl. No.: 16/549,712

(22) Filed: Aug. 23, 2019

Related U.S. Application Data
(60) Provisional application No. 62/723,521, filed on Aug. 28, 2018.

(51) Int. Cl. G06F 21/62

(52) U.S. Cl. CPC G06F 21/6218

(57) ABSTRACT

The present disclosure is directed to centralized de-identification of protected data associated with subjects in multiple modalities based on a hierarchal taxonomy of policies and handlers. In various embodiments, data set(s) associated with subject(s) may be received. Each of the data set(s) may contain data points associated with a respective subject. The data points associated with the respective subject may include multiple data types, at least some of which are usable to identify the respective subject. For each respective subject: a classification of each of the data points may be determined in accordance with a hierarchal taxonomy; based on the classifications, respective handlers for the data points may be identified; and each data point of the plurality of data points may be processed using a respective identified handler, thereby de-identifying the plurality of data points associated with the respective subject.

### CROSS-REFERENCE TO RELATED APPLICATION

This application claims priority to and the benefit of U.S. Provisional Application Ser. No. 62/723,521, filed Aug. 28, 2018, which is incorporated by reference herein it its entirety.

### TECHNICAL FIELD

Various embodiments described herein are directed generally to de-identification of protected data. More particularly, but not exclusively, various methods and apparatus disclosed herein relate to centralized de-identification of protected data in multiple modalities based on a hierarchal taxonomy of policies and handlers.

### BACKGROUND

As technology advances, more and more data is being collected, e.g., from the “internet of things,” as well as from more specialized data sources such as health care equipment and personnel. For example, with the advent of the Electronic Health Record (“EHR”) system, there is an exponential growth in the volume of information (e.g., symptoms, diagnoses, procedures, medications etc.) collected from patients during the course of a treatment. A multi-specialty hospital has many departments resulting in the generation of hundreds of gigabytes of data every day. Also, more and more structured data is being made available for research. As data collection and proliferation becomes more and more ubiquitous, it becomes increasingly important to anonymize various types of protected data while also allowing the data to be leveraged to its full potential. For example, various types of data may be subjected to de-identification or anonymization processing in which data that are usable to identify an individual or group may be scrubbed while other data may be maintained in some form so that it can be used for various beneficial purposes.

Patient healthcare data can be extremely useful for a variety of purposes, such as disease research, development of drugs and other treatments, etc. However, this data is typically considered highly sensitive, and therefore may be covered by national, regional, hospital, or business regulations. Examples include the Health Insurance Portability Act (“HIPAA”) requirements for data privacy in the US, Informatics for Integrating Biology and the Bedside (“i2b2”), Medical Information Mart for Intensive Care (“MIMIC”), business-to-business master research agreements, agreements stipulated by institutional review boards, and so forth. Each set of regulations may impose or alter requirements for how patient healthcare data is handled. This particularly applies to de-identification, in which protected health information (“PHI”) is identified and either modified (e.g., obfuscated) or removed in order to limit risk to patients and care providers. HIPAA lists eighteen such PHI elements that specifically must be removed for a dataset to be considered “de-identified” under that standard. Other agreements or regulations may identify more or fewer elements, or may allow for the elements to be transformed rather than removed, balancing research requirements and other privacy safeguards with re-identification risk.

### SUMMARY

Given the many possible requirements for what constitutes PHI in a particular study or how that PHI is required to be handled, efforts to create a software system capable of producing de-identified output acceptable to all standards have failed. Instead, software systems have been created piecemeal that are tailored for each application. The problem is compounded by the requirement to process many different types of data, such as imaging data, electronic medical record (“EMR”) extracts, waveforms, free text notes, etc., in a consistent manner such that the output of all systems may be linked to form a full multi-modal view of the patient. The traditional solution to this problem has been to create individual software systems that process each type of data, as well as each modality of a data type. Each new type of data to be processed requires re-implementation of the de-identification components, consistent configurations to ensure that all components are treating PHI in an identical way, and methods of ensuring that the output of each isolated processing layer is consistent. This is especially difficult if look-up tables are required (as they often are), and lookup tables must be synced between processing components.

Accordingly, the present disclosure is directed to a framework for centralized de-identification of protected data associated with subjects in multiple modalities based on a hierarchal taxonomy of policies and corresponding handlers. For example, in the healthcare context, techniques described herein may be implemented to provide a centralized platform that is capable of processing multiple data streams containing multiple data types and/or data modalities. The platform may be easily configurable to perform de-identification in accordance with a variety of different regulations, as well as to facilitate other features such as deduplication, auditing, and/or discoverability. In some embodiments, the platform may make use of a hierarchal taxonomy to classify individual data points, as well as to select handlers to process the data points in accordance with their classifications. Techniques disclosed herein create a single software platform and framework to act as a single point of configuration and to perform centralized PHI de-identification for all processing modalities. A flexible configuration syntax is described that can cover HIPAA and other use cases, and be extended as needed to localized requirements. All modality-specific components make use of this central service, ensuring that the outputs are consistently de-identified to meet regulatory requirements and to facilitate creation of a multi-modal linked dataset. Techniques described herein are also applicable in a de-centralized nature. For example, an individual computing device (or computing devices of a remote site, such as a doctor's office) may be configured to perform selected aspects of the present disclosure.

As used herein, a “data type” refers to a type of data, e.g., a source of data. One example of a data type is a subject identifier. Subject identifiers can include what will be referred to herein as “external,” “internal,” and “system” identifiers. An external identifier is a general-purpose identifier (although it may have been initially created for a specific context) that is used in a variety of circumstances beyond a particular context, such as a social security number, a driver's license number, United States Veterans Affairs account number, and so forth. An internal identifier, by contrast, is limited to a particular context. In the healthcare context, internal identifiers may be used within hospital information systems to identify patients, and may include, for instance, a medical record number or a hospital encounter identifier, and are typically available to healthcare personnel and perhaps even patients. A system identifier (e.g., a database row id) is used exclusively in a software/database system and is typically not made available outside of that system (e.g., it is not “surfaced” to patients or medical personnel). Other data types include, but are not limited to, age, contact (e.g., telephone number, email, IP address), datetime (any date and/or time, such as a subject's birthdate, date of admittance, date of treatment, etc.), location (e.g., zip code, street address, state, city, etc.), name (e.g., given name, family name), “no-PHI” (any value known not to be PHI under any definition, such as heart rate), and organization or “org” (e.g., hospital name, name of study or trial, name of study or trial sponsor, etc.).

As used herein, a “data modality” or “modality” refers to a way of expressing a particular data type, e.g., with a particular level of granularity. For example a datetime can be expressed in a number of ways (i.e. modalities), such as ISO 8601. As another example, a location data type can be expressed in various modalities and/or granularities, such as a ZIP code, a street address, a city/state, etc. As yet another example, phone numbers may be expressed in various ways, such as with or without area codes, with or without interspersed commas, and so forth. In various embodiments, various modalities may be captured by regular expressions or other similar means.

Generally, in one aspect, a method for multi-modal, centralized de-identification, may include: receiving, one or more data sets associated with one or more subjects, each of the one or more data sets containing a plurality of data points associated with a respective subject of the one or more subjects, wherein at least some of the plurality of data points associated with the respective subject are usable to identify the respective subject, and wherein the plurality of data points associated with the respective subject include multiple data types; for each respective subject of the one or more subjects: determining a classification of each data point of the plurality of data points associated with the respective subject in accordance with a hierarchal taxonomy, wherein the hierarchal taxonomy defines, for each respective data type of the multiple data types, a sub-taxonomy of modalities associated with the respective data type; based on the classifications, identifying a plurality of respective handlers for the plurality of data points associated with the respective subject, wherein at least one of the handlers is configured to obfuscate or drop a data point of the plurality of data points associated with the respective subject; and processing each data point of the plurality of data points associated with the respective subject using the respective identified handler, thereby de-identifying the plurality of data points associated with the respective subject.

In various embodiments, the one or more subjects may include one or more patients, and the one or more data sets associated with the one or more subjects may include medical records associated with the one or more patients. In various embodiments, the multiple data types of the plurality of data points associated with each respective patient of the one or more patients may include an external identification number associated with the respective patient and a physiological measurement of the respective patient.

In various embodiments, the plurality of data points associated with each respective subject may be received from multiple different data sources, each data source storing a particular data type of the multiple data types. In various embodiments, identifying the plurality of respective handlers for the plurality of data points associated with the respective subject may include identifying, for each given data point of the plurality of data points, the respective handler based on the modality of the given data point. In various embodiments, a data type of the given data point may be a date, and the respective handler may be configured to apply a date shift to the given data point. In various embodiments, a data type of the given data point may be an external identifier that is usable to identify a subject of the one or more subjects, and the respective handler may be configured to obfuscate or drop the external identifier. In various embodiments, a data type of the given data point may be an internal identifier to which external access is limited, and the respective handler may be configured to allow the internal identifier to pass through.

In various embodiments, the method may further include generating a log to track the processing of each data point of the plurality of data points associated with the respective subject, wherein the log may be usable to audit the centralized de-identification.

In addition, some implementations include one or more processors of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating various principles of the embodiments described herein.

FIG. 1 illustrates schematically an example environment in which selected aspects of the present disclosure may be implemented, in accordance with various embodiments.

FIG. 2 illustrates schematically an example hierarchal taxonomy that may be used in various embodiments to classify data associated with a subject.

FIG. 3 depicts an example method of practicing selected aspects of the present disclosure, in accordance with various embodiments.

FIG. 4 illustrates schematically an example computer architecture, in accordance with various embodiments.

### DETAILED DESCRIPTION

As data collection and proliferation becomes more and more ubiquitous, it becomes increasingly important to protect various types of protected data while also allowing the data to be leveraged to its full potential. For example, various types of data may be subjected to de-identification or anonymization processing in which data that are usable to identify an individual or group may be scrubbed while other data may be maintained in some form so that it can be used for various beneficial purposes.

Patient healthcare data can be extremely useful for a variety of purposes, such as disease research, development of drugs and other treatments, etc. However, this data is typically considered highly sensitive, and therefore may be covered by national, regional, hospital, or business regulations. Each set of regulations may impose or alter requirements for how patient healthcare data is handled. This particularly applies to de-identification, in which protected health information (“PHI”) is identified and either modified (e.g., obfuscated) or removed in order to limit risk to patients and care providers. Various agreements or regulations may identify any number elements, or may allow for the elements to be transformed rather than removed, balancing research requirements and other privacy safeguards with re-identification risk. Efforts to create a software system capable of producing de-identified output acceptable to all standards have failed. Instead, software systems have been created piecemeal that are tailored for each application.

Accordingly, the present disclosure is directed to methods and apparatus for centralized de-identification of protected data associated with subjects in multiple modalities based on a hierarchal taxonomy of policies and handlers. For example, in the healthcare context, techniques described herein may be implemented to provide a centralized platform that is capable of processing multiple micro-batched datasets/data streams/sources containing multiple data types and/or data modalities. The platform may be easily configurable to perform de-identification in accordance with a variety of different regulations, as well as to facilitate other features such as deduplication, auditing, and/or discoverability. In some embodiments, the platform may make use of a hierarchal taxonomy to classify individual data points, as well as to select handlers to process the data points in accordance with their classifications. Techniques disclosed herein create a single software service to act as a single point of configuration and to perform centralized PHI de-identification for all processing modalities. A flexible configuration syntax is described that can cover HIPAA and other use cases, and be extended as needed to localized requirements. All modality-specific components make use of this central service, ensuring that the outputs are consistently de-identified to meet regulatory requirements and to facilitate creation of a multi-modal linked dataset. In some embodiments, data from multiple sources for the same patient may be linked longitudinally across various managed health systems like Electronic Medical Record (“EMR”), Electronic Health Records (“HER”), Hospital Information System (“HIS”) and Radiology Information System (“RIS”). This longitudinal linking may be maintained across multiple passes of de-identification carried out at different stages in the life-cycle of a patient.

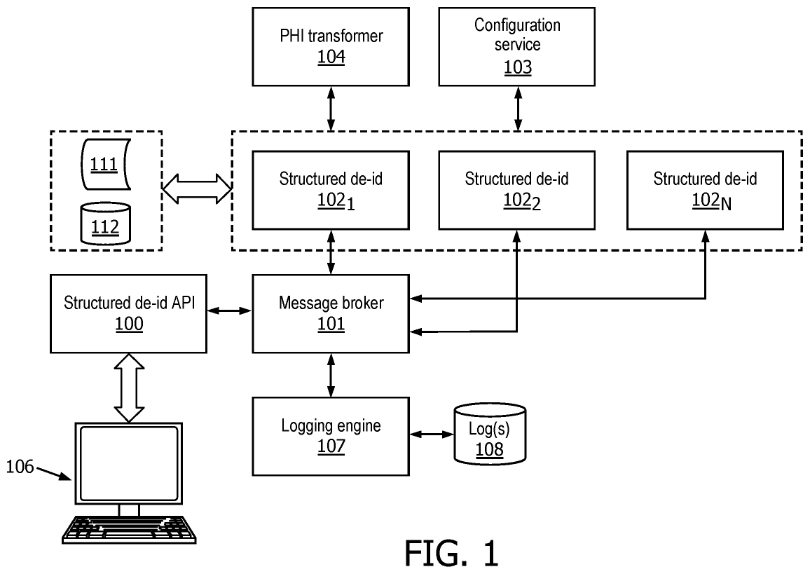

Referring to FIG. 1, an example environment in which selected aspects of the present disclosure may be implemented is depicted schematically, in accordance with some embodiments. Each of the depicted elements or modules may be implemented using any combination of hardware or software. While a particular arrangement of components is depicted in FIG. 1, this is not meant to be limiting. In various embodiments, one or more components/modules may be added, deleted, or its functionality may be distributed across one or more other components/modules. Moreover, the components depicted in FIG. 1 may be implemented across any number of computing systems and computing devices that are communicably coupled with one another over one or more computer networks.

A structured de-id application programming interface (“API”) module 100 may receive, e.g., from one or more client devices 106 operated by medical personnel, researchers, patients, etc., a request that includes or identifies a payload of data to be de-identified. The request may also be made available through detected events, such as when a new dataset arrives or is imported into the system. This provides a continuous de-identification pipeline for the datasets. In some implementations, the request may take the form of a Representational State Transfer call, or “REST.” REST is an architecture style for designing networked applications. More specifically, REST is a commonly-used stateless, client-server, cacheable communications protocol that is often (but not exclusively) used on top of the hypertext transfer protocol (“HTTP”). In other embodiments, other protocols such as the Common Object Request Broker Architecture (“CORBA”), remote procedure calls (“RPC”), or the Simple Object Access Protocol (“SOAP”) may be used in addition to or instead of REST.

In some implementations, the payload may specify, e.g., within external data sources 111 (e.g., remote hospitals, deployed personal physiological sensors, etc.) or internal data sources 112 (e.g., EMRs, hospital information systems, or “HIS”, etc.), input data or other data sources that provide data to be de-identified, as well as locations for storing the resulting de-identified data. Input data may come in various formats, such as coma separate values (“CSV”), relational databases, JavaScript Object Notation (“JSON”), Health Level Seven (“HL7”), Digital Imaging and Communications in Medicine (“DICOM”), Picture Archive and Communication System (“PACS”), and so forth. Additionally or alternatively, in some embodiments, the payload may specify a corresponding schema file that declares the data type and the kind of de-identification required for each data element, and/or the output location where the de-identified data should be stored. The payload may be encoded using various protocols, such as JSON, extensible markup language (“XML”), and so forth.

Client device(s) 106 may include, for example, one or more of: a desktop computing device, a laptop computing device, a tablet computing device, a mobile phone computing device, a computing device of a vehicle of the user (e.g., an in-vehicle communications system, an in-vehicle entertainment system, an in-vehicle navigation system), a standalone interactive speaker, a smart appliance such as a smart television, and/or a wearable apparatus of the user that includes a computing device (e.g., a watch of the user having a computing device, glasses of the user having a computing device, a virtual or augmented reality computing device). Additional and/or alternative client computing devices may be provided.

In response the request received from the client device(s) 106, in various embodiments, structured de-id API module 100 may then send a message to a message broker 101. Message broker 101 may be a message broker software program, sometimes referred to as “message-oriented middleware,” that is configured to queue and relay various messages between various components depicted in FIG. 1. In some implementations, message broker 101 may take the form of a RabbitMQ message bus. RabbitMQ may be used to implement protocols such as the Advanced Message Queuing Protocol (“AMQP”), the Streaming Text Oriented Messaging Protocol (“STOMP”), the Message Queuing Telemetry Transport (“MQTT”), and other protocols. The message sent from structured de-id API module 100 to message broker 101 may indicate that a new de-identification job has been created (i.e. a “job creation message”). Structured de-id API module 100 may also send a job status message to message broker 101 and set the job status to be “in-queue.” In some implementations, the structured de-id API module 100 may also query message broker 101 for the status of a submitted job by sending a query message to message broker 101. Additionally or alternatively, other protocols may be employed to exchange data between components of FIG. 1, such as NiagraFiles (“NiFi”).

One or more structured de-id modules 102_{1-N} may be configured to interface with message broker 101 and listen for job creation messages that they can accept for processing. Each structured de-id module 102 may be configured to locate, based on the job creation message, the input data and the schema files (if present), and to process the input data using techniques described herein, e.g., to generate output data that is de-identified. As will be described below, in some embodiments, each structured de-identification module 102 may classify individual data points of the input data in accordance with a hierarchal taxonomy and then further process the individual data points based on the classifications. In various embodiments, each structured de-id module 102 may update its job status to ‘de-id started’ by sending another message to message broker 101.

In various embodiments, an external configuration service module 103 may be configured to supply configurations that should be used by a given structured de-identification module 102 during its de-identification and/or de-duplication processing of the input data. For example, in some embodiments, a PHI transformer 104 may host (or otherwise proved access to) a library of handlers (e.g., software functions, remote software agents, etc.) that each is configured to perform a particular action (e.g., de-identification, deduplication, etc.) on a particular classified data point. In some embodiments, each structured de-identification module 102 makes specific calls to PHI transformer 104 for the de-identification of specific attributes in the data. If de-identification process succeeds, the structured de-id module 102 may send a ‘de-id complete’ or similar message to message broker 101; otherwise structured de-id module 102 may send a ‘de-id failed’ or similar message to message broker 101. Put another way, message broker 101 maintains a list (or queue) of active de-identification jobs being performed by one or more structured de-id modules 102 based on requests received at structured de-id API 100.

Configuration service module 103 may act as a single point of configuration available to users, so that users are able to customize and/or create new policies and/or handlers to deal with various types of data as needed. The configuration(s) maintained by configuration service module 103 may be extensible to support different data types and/or different data modalities, and/or to adjust various handlers and aspects of handlers, such as which hash type is used, which dateshift is employed, and so forth. In some implementations, configuration service module 103 may be operable to provide centralized storage, validation, and versioning of all system configurations.

In various implementations, a logging engine 107 may listen (e.g., periodically poll) the job queue maintained by message broker 101 and record the status in one or more logs 108 (e.g., a plain text file or postgreSQL database). Logging engine 107 may also return the status of a de-identification job if a query message is sent to message broker 101. In some embodiments, logging engine 107 may create logs 108 for a variety of purposes, such as auditing, provenance tracking, and so forth.

As noted previously, in various implementations, techniques described herein may rely on a hierarchal taxonomy to classify individual data points of input data. These classifications may be used, e.g., by structured de-id modules 102_{1-N}, to select handlers, e.g., from a library of handlers provided by PHI transformer 104. The selected handlers may then be applied to (e.g., used to process) the input data to generate de-identified and/or de-duplicated data that is usable for various purposes, such as studies, research, etc. Each handler may operate on a particular data type and/or modality. Individual data points may be obtained from a variety of sources (e.g., from 111 and/or 112), such as structured data files (e.g., JSON, CSV, etc., which may contain recorded physiological measurements, lab results, treatments applied, prescriptions, diagnoses, etc.), detected in images from DICOM or PACS data (e.g., detected within the images such as CT scans or MRI data, or within associated metadata), extracted from EMRs (which could include free-form text that describes diagnoses, treatments, prescriptions, etc.), obtained from streams of data produced by various medical equipment (e.g., heartrate sensors, weight scales, glucose meters, pulse oximeters, etc.), and so forth.

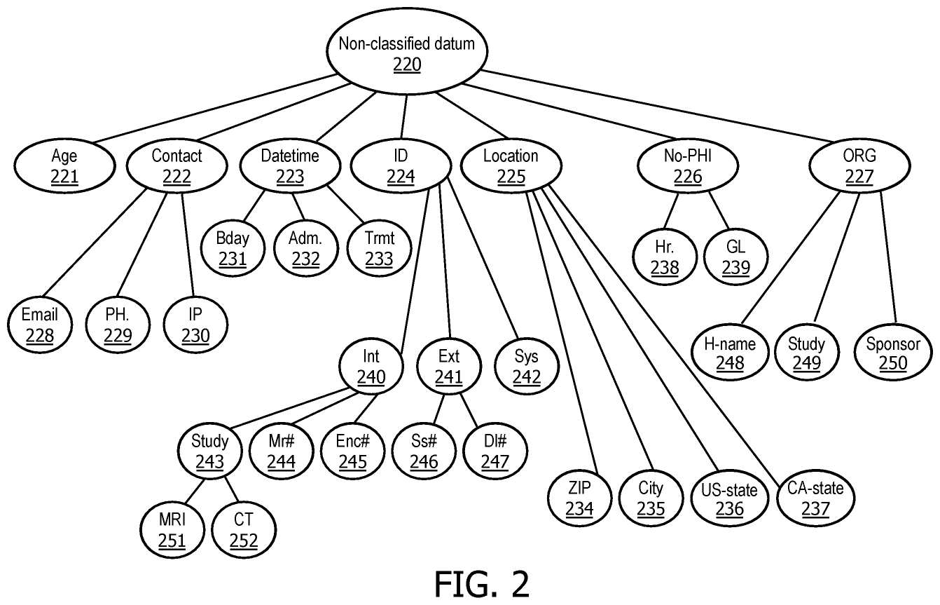

FIG. 2 schematically depicts one example of a hierarchal taxonomy that may be used in various embodiments. Starting at root node 220, a data point may be first classified with a general data type, such as age 221, contact 222, datetime 223, ID 224, location 225, no-PHI (i.e., non-protected health information) 226, and organization (ORG) 227. At least some of the data types may include a sub-taxonomy of modalities. For example, contact 222 may have sub-modalities of email 228, telephone (“PH”) 229, and IP address 230, among others. Datetime 223 may have sub-modalities of birthday 231, admission date/time 232, treatment date/time 233, and so forth.

As noted previously, ID 224 may have sub-modalities of internal 240, external 241, and system 242, among others. In some embodiments, each of these sub-modalities 240-242 may itself have a sub-taxonomy of modalities. For example, internal 240 has sub-modalities of study identification number 243, medical record number 244, and hospital encounter number 245, among others. External 241 has sub-modalities of social security number 246 and driver's license number 247, among others. And study identification number 243 has sub-modalities of MRI scan number 251 and CT scan number 252, among others.

Location 225 has a sub-taxonomy of modalities that include ZIP code 234, city 235, US-state 236, Canadian state CA-state 237, and may include various other modalities as applicable. ORG 227 includes a sub-taxonomy of modalities that includes hospital name 248, study (or trial) name 249, and study sponsor 250.

No-PHI 226 has a sub-taxonomy of modalities that includes, for instance, physiological parameters and other data points that are not usable (at least alone) to identify a subject. In FIG. 2, for instance, no-PHI 226 includes heartrate 238 and glucose level 239. These are not meant to be limiting, and any other physiological parameter may be included in a hierarchal taxonomy as described herein. Indeed, techniques described herein allow for the handling of a wide variety of physiological data, such as structured data received from physiological sensors (which may be organized, for instance, in JSON) and other types of data, such data formatted in the DICOM or PACS standards.

Data points or streams of data that are to be processed using techniques described herein may be classified using a hierarchal taxonomy such as that depicted in FIG. 2. In some embodiments, an initial set of PHI data types (e.g., 221-227) is defined as a starting point, to cover a majority of use cases, and to serve as a basis for additional customization. The hierarchal taxonomy may be configured to define increasing levels of detail of PHI data type (i.e., sub-taxonomies of modalities for each data type as described above).

In some embodiments, each data point (or data points) may be classified or “tagged” with a PHI classification that includes a full path in the hierarchal taxonomy, which in examples described herein are separated by colons (‘:’) though this is not meant to be limiting. For example, an MRI identifier for a particular study may be classified or tagged as “id:int:study-id:mri.” A CT identifier for a particular study may be classified or tagged as “id:int:study-id:ct.” A United States Veterans Affairs account number may be classified or tagged as ‘id:ext:account-no:us-va.” And so on.

The data classifications determined using a hierarchal taxonomy such as that depicted in FIG. 2 may be used, along with their corresponding policies, to determine how each data point of input is handled (e.g., de-identified, unaltered or passed through, dropped, etc.). In some embodiments, a classification of a data point (or a set or stream of data points sharing a type/modality) may be associated with a particular policy. The policy may identify a handler to be used, e.g., by one or more structured de-id modules 102_{1-N}, to process the data point(s). In other words, policies are defined using the hierarchal taxonomy. In some embodiments, general PHI classes (e.g. ‘id’) may have a fail-safe policy, and more specific or granular classes (e.g. ‘id:int:awn’) may be granted a more permissive policy that includes a handler that does something other than drop the data point (e.g., obfuscate, shift, mask, etc.) as required to allow research.

In some embodiments, the most specific or granular applicable policy may be applied for each tag handled by the PHI transformer 104 (in FIG. 1). Suppose an incoming data element was tagged “id:int:mrn.” That may match the policy for ID 224 (in FIG. 2) which may map to a “drop” handler (e.g., delete or remove data), and it may also match the policy for “id:int:mrn” (244 in FIG. 2), which may be “lookup-table.” In this case, “id:int:mrn” (244) is the more specific or granular policy and therefore a different handler would be applied to the data point. In some implementations, the default policy handler for a high-level classification of potential PHI may be “drop.” If a given data point does not match any more specific classification in the policy then the data point may be redacted and/or replaced with a label such as “removed”.

In some embodiments, PHI policies may be defined using the JSON format. The following is one non-limiting example:

```
{
  ‘datetime’: ‘datetime-global-shift’,
  ‘id’: ‘drop’,
  ‘id:int’: ‘lookup-table’,
  ‘id:sys:row-id’: ‘passthrough’,
  ‘location’: ‘drop’
}
```

This policy indicates that all data points classified as datetimes will be transformed using a “datetime-global-shift” handler. Data points classified as identifiers (“id”) will be dropped by default, however internal (“id:int”) identifiers will be mapped to handlers, e.g., by PHI transformer 104, using a lookup table. Data points classified as “id:sys:row-id” (e.g., database row ids) will be allowed through unmodified (“passthrough”). Data points classified as locations (e.g., ZIP codes, cities, states, etc.) will be dropped.

As noted previously, a library of handlers may be maintained, e.g., by PHI transformer 104. In some embodiments there may be a variety of default PHI handlers available to handle the majority of cases. The following sub-sections list non-limiting examples of policies, each including a policy name (in quotes), description, and input, output, and configuration options of each policy handler.

### ‘age-handler-basic’: Basic Processing of Patient Age

In accordance with HIPAA and other policies, patient ages of 90 or above may be considered special PHI, e.g., due to the scarcity of such patients. This handler considers tagged elements as ages—values below a threshold are passed through unmodified. Ages equal to and/or above the threshold are substituted for the configured value.

Input: Numeric age, years

Configuration Options:

Threshold for cutoff, years

Replacement value, numeric, default ‘130’—allows comparison operators to work as expected (‘greater than’, ‘less than’), large enough to be apparent as artificial, while still being near to physiological possibility.

Output: Numeric age, years

### ‘datetime-global-shift’: Global Datetime Shift

This is the default handler for datetime values in some embodiments. It applies a global shift to all data points having the data type of datetime. In some implementations, datetime input are expected to comply with ISO 8601, including source time zone. The default output may be converted, for instance, to Greenwich Mean Time (“GMT”), which eliminates possibility of location leakage through time zone information, or date leakage through daylight savings time information. In some embodiments, the date shift is specified in days, as a shift of years can result in nonsensical dates due to leap years (e.g. Feb. 29, 2043).

Input: Datetime in ISO 8601 format. If no time zone is specified, offset of +0 may be assumed.

Configuration options for this handler may include:

Number of days to shift the output

Output time zone (default ‘GMT’, 0 time offset)

Output: Datetime using ISO 8601 standard, including time zone

### ‘drop’: Removal of Original Value

Element is removed, replaced with the value “<removed>”.

### ‘hash’: Hashing Function

This handler passes the data point through one or more defined hashing functions.

Input: Any data element

The following are non-limiting configuration options:

Hash level (‘Low’, ‘Medium’, or ‘High’): security level of hash function, could map to, for instance, md5, ssh512, and pbkdf2_hmac, although other mappings are possible.

Salt: Salt of hash function, kept secret from all downstream processes. Salt is random data that is used as additional input to a one-way hash function. Salts are beneficial because, for instance, they defend against attacks such as dictionary attacks and/or pre-computed rainbow table attacks.

Output: Hashed output

### ‘lookup-table’: Dynamic Lookup Table Creation and Value Replacement

The data point is referenced against a defined lookup table, which may be segregated according to the complete PHI hierarchal taxonomy. If an existing element is discovered then the existing lookup value is returned, otherwise a new UUID is generated, added to the lookup table, and returned.

As an example, if MRN “55” and encounter ID “55” both exist and are labeled by general PHI classification as ‘id’, they will both receive the same UUID conversion. However, if they are properly classed by subtypes as ‘id:int:mrn’ and ‘id:int:encounter-id’, they will be sorted in separate lookup tables and be assigned unique identifiers.

Input: Any data element

Output: UUID

### ‘passthrough’: Pass-Through of Original Value

Data element is unmodified and returned in original form.

Additionally or alternatively, in some embodiments there may be an expandable library of special PHI handlers that may be required by various sites or localities. The following sub-sections list non-limiting examples of such policies, with the policy name in quotes, description, and input, output, and configuration options of each transformation.

### ‘age-handler-advanced’: Advanced Age Handling with Multi-Resolution De-Identification

This handler builds on the basic age handler with the implementation of age resolution reduction. Various policies or regulations may require that patients of different ages have varying levels of resolution retained in their ages. For example, it may be necessary for neonatal intensive care unit (“NICU”) algorithm development that the patient's age is available at a day resolution, whereas older patients' ages may be limited to year resolution, or binned into 2, 5, or 10 year increments, depending on the potential numbers of patients in those age ranges.

This handler allows definition of age cutoffs and resolutions, where cutoffs and resolutions are specified as pairs (cutoff₁, resolution₁), (cutoff₂, resolution₂), . . . (cutoffₙ, resolutionₙ), where ages from 0 to cutoff₁ (days) are down-sampled to resolution₁, ages from cutoff₁ to cutoff₂ are down-sampled to resolution₂, etc., and ages above cutoffₙ are replaced with an old age replacement value. Default values replicate the functionality of the basic age handler.

Input: Age in years, which may be an integer greater than or equal to zero in some embodiments.

Configuration options are:

List of (age-cutoff, resolution): age-cutoff (days) specifies a boundary age, resolution (days) specifies resolution of down-sampling. Default is (32850, 365), which corresponds to a 90 year threshold, with ages less than 90 being down-sampled to 1-year increments.

Old Age Replacement Value: 47450 (130 years in days), same default as basic age handler, or some other value.

Output: Age in years, which may be an integer greater than or equal to zero in some embodiments.

### ‘birthday’: Date of Birth Handling

Ages greater than ninety may be considered PHI according to HIPAA and other policies, along with any other information that could be used to derive age, e.g. date of birth. The result of this policy is that dates that are birthdates may not simply be shifted, but must first be used to calculate the person's age relative to some recent baseline date (e.g. date of hospital admission), evaluated relative to the PHI cutoff threshold (e.g., ninety years), and either shifted, shifted with resolution reduction, or replaced. Ages may be calculated from the input reference datetime to the birthday. Calculated ages may be processed with the ‘age’ handler as defined in the policy. If none is present, this handler may default to the ‘age-handler-basic’. Ages may then be subtracted from the reference time, and may be shifted using the ‘datetime’ policy. If ‘datetime’ policy is contextual date shift, required elements may be passed to this function as well.

Input: Date of birth, reference date, additional contextual data if ‘contextual-datetime-shift’ is selected. ISO 8601 format

Output: Date, ISO 8601 format

### ‘contextual-datetime-shift’: Contextual Datetime Shift

For wider release de-identification scenarios (e.g. creation of public datasets), a global date shift may be considered insufficient to mitigate re-identification risk, as any single patient's data may be used to discover the shift for all patients. In these instances a contextual date shift may be used. Every patient may have a different (e.g., unique) dateshift, or every ICU encounter, every hospital encounter, etc. With this handler, all events from the same context (e.g. hospital encounter) may receive the same dateshift and may be chronologically ordered relative to one another, but events from different contexts may receive different date shifts. In some implementations, for a given context, a random date shift may be chosen between the specified minimum and maximum shifts. Day of week and seasonality are optionally preserved.

Input: Datetime in ISO 8601 format. If no time zone is specified, offset of +0 is assumed.

Context: list of (phi-type, phi-value), as required by configuration

Here are some example configuration options:

Minimum date shift (days), default 50 years (18250 days)

Maximum date shift (days), default 75 years (27375 days)

Output time zone (default ‘GMT’, 0 time offset)

Preserve day-of-week (Boolean), default True

Preserve season (Boolean), default True

Required context: list of phi-type, e.g. [′id:int:mrn′, ‘id:int:encounter-id’] for per-encounter time shift

Output: Datetime in ISO 8601 format, including time zone

### ‘defined-lookup-table’: Defined Lookup Table Replacement

This handler may use lookup tables to substitute values (e.g. city or hospital names) with human-friendly names.

Input: string or numeric value

Configuration Options:

Set of lookup tables, dictionary with keys of phi-type, and values as another dictionary specifying the key-value pairs of the lookup table.

Output: Mapped return value. If lookup table is not found, return value is ‘<table-not-found>’. If table is found but value is not found, return value is ‘<lookup-key-not-found>’.

### ‘lookup-table-formatted’: Value Replacement with a Formatted Random Value

Many identifiers are given in a characteristic format, and some systems that expect these formats can break if arbitrary UUIDs or random values are presented. Examples include US social security numbers (###-##-####) and US phone numbers ((###) ###-####)).

For each phi-type a lookup table is generated, and random strings are generated according to the defined pattern until a unique string is found, up to 10 attempts before failure.

In some embodiments, if the input expression does not have sufficient space for entropy it may become impossible to randomly assign new values. For example, the pattern ‘[0-9]’ will generate a single digit 0-9, but can only create 10 total unique values, and will fail if an 11th is requested.

Input: value

Configuration Options:

Set of formats, dictionary with keys of phi-type, values as regular expressions (see https://github.com/crdoconnor/xeger for examples).

Output: formatted replacement value. Value ‘<insufficient-entropy>’ if values cannot be discovered.

### ‘fixed-value’: Fixed Value Replacement

Returns constant value as defined

Input: value

Configuration options: Dictionary with keys of phi-type, values as fixed replacement value

Output: Replacement value

### ‘regex-replace’: Masking

Replace input via regular expression. E.g. can be used to retain a US telephone area code of a phone number with following pattern: ‘\((\d{3}) \) \d{3}-\d{4}’ ‘\1 xxx-xxxx’, which will replace ‘(123) 456-7890’ with ‘(123) xxx-xxxx’.

Input: string

Configuration options: Dictionary with keys of phi-type, values as search and replace regex.

Output: modified string

### ‘us-location’: United States Location Processing

Implementation of HIPAA rules on US location processing of zip codes

Input: US zip code

Output: HIPAA-compliant US zip code

### ‘value-noise’: Noising

This policy handler may be used to add numeric noise to input, to prevent any patient from matching actual data completely. This is intended to prevent an attacker with knowledge of a single patient from identifying that patient in the dataset.

Input: numeric value

Configuration options: Dictionary with keys of phi-type, variance of Gaussian noise distribution to sample noise factor

Output: N(input, \sigma²)

The following table contains a non-limiting example of input data that may be identified in a payload of a request received at structured de-id API 100, and which is to be processed (e.g., de-identified) by components such as one or more structured de-id modules 102_{1-N}. Each row of the table corresponds to a particular medical event, but this is not intended to be limiting, and input data may take other forms.

EXAMPLE INPUT TO BE DE-IDENTIFIED

{“RESULT_VAL”: “”, “RESULT_UNITS”: “”, “SNOMED_CODE”:
“43173001”, “Deid_MRN”: “10013”, “PERFORMED_DT_TM”:
“2001-06-16T18:03:00”, “EVENT”: “Orientation”}
{“RESULT_VAL”: “”, “RESULT_UNITS”: “”, “SNOMED_CODE”:
“43173001”, “Deid_MRN”: “10013”, “PERFORMED_DT_TM”:
“2001-06-18T11:57:00”, “EVENT”: “Orientation”}
{“RESULT_VAL”: “1.12”, “RESULT_UNITS”: “mg/dL”,
“SNOMED_CODE”: “70901006”, “Deid_MRN”: “10013”,
“PERFORMED_DT_TM”: “2001-06-18T13:42:00”, “EVENT”:
“Creatinine”}
{“RESULT_VAL”: “36.8”, “RESULT_UNITS”: “DegC”,
“SNOMED_CODE”: “123979008”, “Deid_MRN”: “10013”,
“PERFORMED_DT_TM”: “2001-06-17T21:26:00”, “EVENT”:
“Temp C”}
{“RESULT_VAL”: “88”, “RESULT_UNITS”: “kg”,
“SNOMED_CODE”: “225171007”, “Deid_MRN”: “10013”,
“PERFORMED_DT_TM”: “2001-06-15T20:13:00”, “EVENT”:
“Weight (kg)”}

The following table contains a non-limiting example of a corresponding input schema which also may be identified in a payload of a request received at structured de-id API 100. Each row specifies how a particular type of data in the input data above should be handled (e.g., de-identified, dropped, etc.).

EXAMPLE INPUT SCHEMA

```
{
  “path”: “$.Deid_MRN”,
  “datatype”: “string”,
  “PHIClass”: “patientID”,
  “description”: “”
}
{
  “path”: “$.PERFORMED_DT_TM”,
  “datatype”: “datetime”,
  “PHIClass”: “datetime”,
  “description”: “”
}
{
  “path”: “$.SNOMED_CODE”,
  “datatype”: “string”,
  “PHIClass”: “NonPHI”,
  “description”: “”
}
{
  “path”: “$.EVENT”,
  “datatype”: “string”,
  “PHIClass”: “NonPHI”,
  “description”: “”
}
{
  “path”: “$.RESULT_VAL”,
  “datatype”: “numeric”,
  “PHIClass”: “NonPHI”,
  “description”: “”
}
{
  “path”: “$.RESULT_UNITS”,
  “datatype”: “string”,
  “PHIClass”: “NonPHI:Enumerated”,
  “description”: “”
}
```

The first field of the sample input schema set forth above is a string having the path “$.Deid_MRN,” wherein “$” may represent a path variable and “MRN” stands for “medical record number,” and which is labeled under “Deid_MRN” in the example input data above. The first field has a class of “patientID,” which may be PHI and therefore may be processed using a “patientID” handler to obfuscate the patient's identity. The second field has a type of “PERFORMED_DT_TM” and specifies that the datetime at which the event occurs should be handled using the “datetime” handler, which may, for instance, shift or otherwise obfuscate the date. The last four entries of the schema specify handlers for non-protected health information (“NonPHI” or “noPHI” elsewhere herein), and include, from top to bottom, a SNOMED_CODE code that identifies the medical event, an event (“EVENT” in the input data above), a RESULT value (e.g., numeric), and RESULT_UNITS (e.g., kg, ml, etc.)

The following table contains an example of de-identified output of the sample input data set forth above, as it might appear after processing using techniques described herein using the input schema set forth above.

EXAMPLE DE-IDENTIFIED OUTPUT

{u‘RESULT_VAL’: ‘REMOVED:INVALID NUMBER’, u‘RESULT_UNITS’: u‘’,
u‘SNOMED_CODE’: u‘43173001’, u‘Deid_MRN’:
u‘MRN:c25b3c94bafec0f972729bc163b258a8’, u‘PERFORMED_DT_TM’:
datetime.datetime(2041, 6, 29, 18, 3, tzinfo=tzutc( )),
u‘EVENT’: u‘Orientation’}
{u‘RESULT_VAL’: ‘REMOVED:INVALID NUMBER’, u‘RESULT_UNITS’: u‘’,
u‘SNOMED_CODE’: u‘43173001’, u‘Deid_MRN’:
u‘MRN:c25b3c94bafec0f972729bc163b258a8’, u‘PERFORMED_DT_TM’:
datetime.datetime(2041, 7, 1, 11, 57, tzinfo=tzutc( )),
u‘EVENT’: u‘Orientation’}
{u‘RESULT_VAL’: u‘1.12’, u‘RESULT_UNITS’: u‘mg/dL’,
u‘SNOMED_CODE’: u‘70901006’, u‘Deid_MRN’:
u‘MRN:c25b3c94bafec0f972729bc163b258a8’, u‘PERFORMED_DT_TM’:
datetime.datetime(2041, 7, 1, 13, 42, tzinfo=tzutc( )),
u‘EVENT’: u‘Creatinine’}
{u‘RESULT_VAL’: u‘36.8’, u‘RESULT_UNITS’: u‘DegC’,
u‘SNOMED_CODE’: u‘123979008’, u‘Deid_MRN’:
u‘MRN:c25b3c94bafec0f972729bc163b258a8’, u‘PERFORMED_DT_TM’:
datetime.datetime(2041, 6, 30, 21, 26, tzinfo=tzutc( )),
u‘EVENT’: u‘Temp C’}
{u‘RESULT_VAL’: u‘88’, u‘RESULT_UNITS’: u‘kg’, u‘SNOMED_CODE’:
u‘225171007’, u‘Deid_MRN’:
u‘MRN:c25b3c94bafec0f972729bc163b258a8’, u‘PERFORMED_DT_TM’:
datetime.datetime(2041, 6, 28, 20, 13, tzinfo=tzutc( )),
u‘EVENT’: u‘Weight (kg)’}

It can be seen in these results that the patient's medical record number, which originally was “10013,” has been transformed into a unique identifier, “c25b3c94bafec0f972729bc163b258a8.” Likewise, the input data in the field “PERFORMED_DT_TM” has been transformed. For example, the input datetime “2001-06-16T18:03:00” in the first input entry has been transformed (e.g., de-identified) into “datetime.datetime(2041, 6, 29, 18, 3, tzinfo=tzutc( ))”, which in relevant part indicates the date as being in the year 2041. Similarly, the “PERFORMED_DT_TIME” in the second input entry has been transformed from “2001-06-18T11:57:00” to “datetime.datetime(2041, 7, 1, 11, 57, tzinfo=tzutc( ))”, which in relevant part indicates the date as once again being in the year 2041.

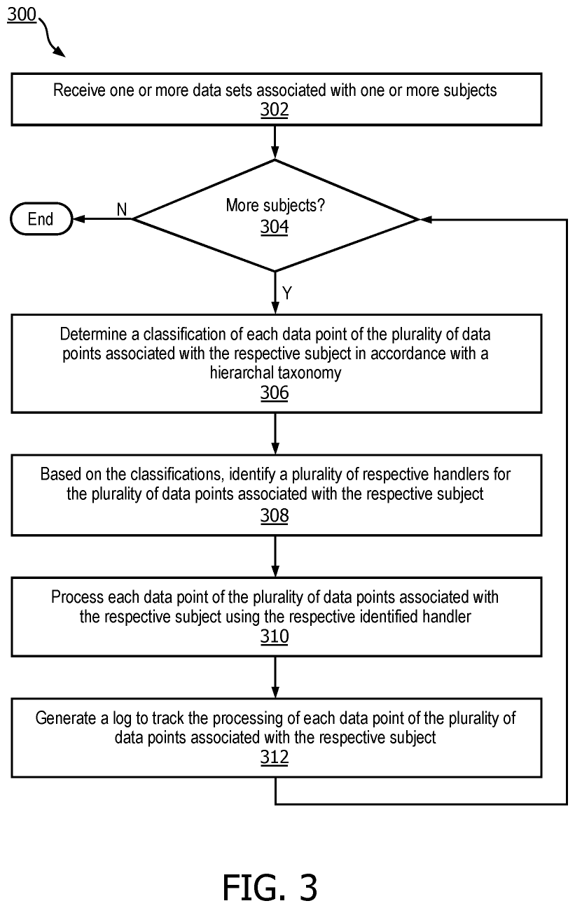

FIG. 3 depicts an example method 300 for practicing selected aspects of the present disclosure, in accordance with various embodiments. For convenience, the operations of the flow chart are described with reference to a system that performs the operations. This system may include various components of various computer systems, including components depicted in FIG. 1. Moreover, while operations of method 300 are shown in a particular order, this is not meant to be limiting. One or more operations may be reordered, omitted or added.

At block 302, the system may receive one or more data sets (e.g., identified in the payload received by structured de-id API 100) associated with one or more subjects, such as one or more patients (although this is not required). Each of the one or more data sets may contain a plurality of data points associated with a respective subject of the one or more subjects. For example, a data set may include data about multiple events associated with a single patient (e.g., as set forth in the example input data above) or events associated with multiple patients. At least some of the plurality of data points associated with the respective subject may be usable, e.g., by malicious parties, to identify the respective subject. Additionally, the plurality of data points associated with the respective subject may include multiple data types, such as those depicted in FIG. 2 (e.g., 221-227).

At block 304, a loop may begin to process the data for each respective subject of the one or more subjects, and a determination may be made whether there is additional data, and to select data for a given patient if one is available. At block 306, the system may determine a classification of each data point of the plurality of data points associated with the respective subject in accordance with a hierarchal taxonomy. As discussed previously, the hierarchal taxonomy may define, for each respective data type of the multiple data types, a sub-taxonomy of modalities (e.g., 228-252) associated with the respective data type.

At block 308, the system may, based on the classifications, identify a plurality of respective handlers for the plurality of data points associated with the respective subject. In various embodiments, at least one of the handlers may be configured to de-identify, e.g., obfuscate or drop, a data point of the plurality of data points associated with the respective subject. In some embodiments the operations of block 308 may be performed in whole or in part by PHI transformer 104, e.g., based on configuration information supplied by configuration service module 103.

At block 310, the system, e.g., by way of one or more structured de-id modules 102_{1-N}, may process each data point of the plurality of data points associated with the respective subject using the respective identified handler. The operation(s) of block 310 may, in effect, de-identify the plurality of data points associated with the respective subject. Once the data points are de-identified, they may be used for a variety of purposes, such as research, clinical trials, and so forth, without risking nefarious parties being able to identify individual subjects based on the de-identified data.

At block 312, the system, e.g., by way of logging engine 107, may generate a log to track the processing (block 310) of each data point of the plurality of data points associated with the respective subject. For example, a log may be created as a file or in database (e.g., 108 in FIG. 1) that indicates aspects of the processing such as what de-identification operations were performed, which handlers were used, which classifications applied, and so forth. In some implementations, the log may be auditable so that the processing can be reversed, effectively “re-identifying” the plurality of data points. For example, the log may include a two-way mapping between a subject's identifier (e.g., social security number, driver's license number, etc.) and a unique identifier generated therefrom. Additionally or alternatively, the log may include indications of what sort of datetime shifts were applied to input data of data type datetime. This is particularly beneficial when a different contextual date/time-shift is applied to each point of data. Of course, under such circumstances the log and/or logging engine may be protected, e.g., hosted within a secure site or system that is inaccessible to and/or protected from unauthorized parties.

Although examples described herein have primarily been focused on de-identification of healthcare-related data, e.g., for studies, trials, research, etc., this is not meant to be limiting. Techniques described herein may be applicable in a variety of other contexts in which it is desirable to de-identify data. For example, techniques and the platform described herein may be employed to de-identify data that is being transmitted from a secure site to a less secure site. Likewise, techniques described herein may be used to roll back the de-identification (re-identification) when data is returned from the less secure site back to the secure site. Moreover, techniques described herein are applicable across a variety of domains in addition to healthcare, such as finance, consumer data, or other domains in which de-identified protected data can be used for various purposes.

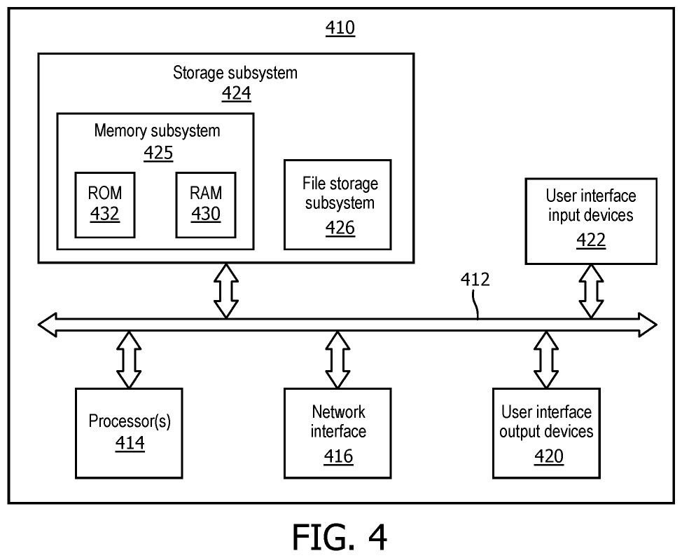

FIG. 4 is a block diagram of an example computing device 410 that may optionally be utilized to perform one or more aspects of techniques described herein. Computing device 410 typically includes at least one processor 414 which communicates with a number of peripheral devices via bus subsystem 412. These peripheral devices may include a storage subsystem 424, including, for example, a memory subsystem 425 and a file storage subsystem 426, user interface output devices 420, user interface input devices 422, and a network interface subsystem 416. The input and output devices allow user interaction with computing device 410. Network interface subsystem 416 provides an interface to outside networks and is coupled to corresponding interface devices in other computing devices.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 410 to the user or to another machine or computing device.

Storage subsystem 424 stores programming and data constructs that provide the functionality of some or all of the modules described herein. For example, the storage subsystem 424 may include the logic to perform selected aspects of the method of FIG. 3, as well as to implement various components depicted in FIG. 1.

These software modules are generally executed by processor 414 alone or in combination with other processors. Memory 425 used in the storage subsystem 424 can include a number of memories including a main random access memory (RAM) 430 for storage of instructions and data during program execution and a read only memory (ROM) 432 in which fixed instructions are stored. A file storage subsystem 426 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 426 in the storage subsystem 424, or in other machines accessible by the processor(s) 414.

Bus subsystem 412 provides a mechanism for letting the various components and subsystems of computing device 410 communicate with each other as intended. Although bus subsystem 412 is shown schematically as a single bus, alternative implementations of the bus subsystem may use multiple busses.

Computing device 410 can be of varying types including a workstation, server, computing cluster, blade server, server farm, or any other data processing system or computing device. Due to the ever-changing nature of computers and networks, the description of computing device 410 depicted in FIG. 4 is intended only as a specific example for purposes of illustrating some implementations. Many other configurations of computing device 410 are possible having more or fewer components than the computing device depicted in FIG. 4.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03. It should be understood that certain expressions and reference signs used in the claims pursuant to Rule 6.2(b) of the Patent Cooperation Treaty (“PCT”) do not limit the scope.

What is claimed is:

1. A method for multi-modal, centralized de-identification, the method implemented using one or more processors and comprising:
receiving, one or more data sets associated with one or more subjects, each of the one or more data sets containing a plurality of data points associated with a respective subject of the one or more subjects, wherein at least some of the plurality of data points associated with the respective subject are usable to identify the respective subject, and wherein the plurality of data points associated with the respective subject include multiple data types;
for each respective subject of the one or more subjects:
determining a classification of each data point of the plurality of data points associated with the respective subject in accordance with a hierarchal taxonomy, wherein the hierarchal taxonomy defines, for each respective data type of the multiple data types, a sub-taxonomy of modalities associated with the respective data type;
based on the classifications, identifying a plurality of respective handlers for the plurality of data points associated with the respective subject, wherein at least one of the handlers is configured to obfuscate or drop a data point of the plurality of data points associated with the respective subject; and
processing each data point of the plurality of data points associated with the respective subject using the respective identified handler, thereby de-identifying the plurality of data points associated with the respective subject.

2. The method of claim 1, wherein the one or more subjects comprise one or more patients, and the one or more data sets associated with the one or more subjects include medical records associated with the one or more patients.

3. The method of claim 2, wherein the multiple data types of the plurality of data points associated with each respective patient of the one or more patients include an external identification number associated with the respective patient and a physiological measurement of the respective patient.

4. The method of claim 1, wherein the plurality of data points associated with each respective subject are received from multiple different data sources, each data source storing a particular data type of the multiple data types.

5. The method of claim 1, wherein identifying the plurality of respective handlers for the plurality of data points associated with the respective subject includes identifying, for each given data point of the plurality of data points, the respective handler based on the modality of the given data point.

6. The method of claim 5, wherein a data type of the given data point is a date, and the respective handler is configured to apply a date shift to the given data point.

7. The method of claim 5, wherein a data type of the given data point is an external identifier that is usable to identify a subject of the one or more subjects, and the respective handler is configured to obfuscate or drop the external identifier.

8. The method of claim 5, wherein a data type of the given data point is an internal identifier to which external access is limited, and the respective handler is configured to allow the internal identifier to pass through.

9. The method of claim 1, further comprising generating a log to track the processing of each data point of the plurality of data points associated with the respective subject, wherein the log is usable to audit the centralized de-identification.

10. At least one non-transitory computer-readable medium comprising instructions that, in response to execution of the instructions by one or more processors, cause the one or more processors to perform the following operations:
receiving, one or more data sets associated with one or more subjects, each of the one or more data sets containing a plurality of data points associated with a respective subject of the one or more subjects, wherein at least some of the plurality of data points associated with the respective subject are usable to identify the respective subject, and wherein the plurality of data points associated with the respective subject include multiple data types;
for each respective subject of the one or more subjects:
determining a classification of each data point of the plurality of data points associated with the respective subject in accordance with a hierarchal taxonomy, wherein the hierarchal taxonomy defines, for each respective data type of the multiple data types, a sub-taxonomy of modalities associated with the respective data type;
based on the classifications, identifying a plurality of respective handlers for the plurality of data points associated with the respective subject, wherein at least one of the handlers is configured to obfuscate or drop a data point of the plurality of data points associated with the respective subject;
processing each data point of the plurality of data points associated with the respective subject using the respective identified handler, thereby de-identifying the plurality of data points associated with the respective subject.

11. The at least one non-transitory computer-readable medium of claim 10, wherein the one or more subjects comprise one or more patients, and the one or more data sets associated with the one or more subjects include medical records associated with the one or more patients.

12. The at least one non-transitory computer-readable medium of claim 11, wherein the multiple data types of the plurality of data points associated with each respective patient of the one or more patients include an external identification number associated with the respective patient and a physiological measurement of the respective patient.

13. The at least one non-transitory computer-readable medium of claim 10, wherein the plurality of data points associated with each respective subject are received from multiple different data sources, each data source storing a particular data type of the multiple data types.

14. The at least one non-transitory computer-readable medium of claim 10, wherein identifying the plurality of respective handlers for the plurality of data points associated with the respective subject includes identifying, for each given data point of the plurality of data points, the respective handler based on the modality of the given data point.

15. The at least one non-transitory computer-readable medium of claim 14, wherein a data type of the given data point is a date, and the respective handler is configured to apply a date shift to the given data point.

16. The at least one non-transitory computer-readable medium of claim 14, wherein a data type of the given data point is an external identifier that is usable to identify a subject of the one or more subjects, and the respective handler is configured to obfuscate or drop the external identifier.

17. The at least one non-transitory computer-readable medium of claim 14, wherein a data type of the given data point is an internal identifier to which external access is limited, and the respective handler is configured to allow the internal identifier to pass through.

18. The at least one non-transitory computer-readable medium of claim 10, further comprising instructions for generating log to track the processing of each data point of the plurality of data points associated with the respective subject, wherein the log is usable to audit the centralized de-identification.

19. A system comprising one or more processors and memory operably coupled with the one or more processors, wherein the memory stores instructions that, in response to execution of the instructions by one or more processors, cause the one or more processors to perform the following operations:
receiving, one or more data sets associated with one or more subjects, each of the one or more data sets containing a plurality of data points associated with a respective subject of the one or more subjects, wherein at least some of the plurality of data points associated with the respective subject are usable to identify the respective subject, and wherein the plurality of data points associated with the respective subject include multiple data types;
for each respective subject of the one or more subjects:
determining a classification of each data point of the plurality of data points associated with the respective subject in accordance with a hierarchal taxonomy, wherein the hierarchal taxonomy defines, for each respective data type of the multiple data types, a sub-taxonomy of modalities associated with the respective data type;
based on the classifications, identifying a plurality of respective handlers for the plurality of data points associated with the respective subject, wherein at least one of the handlers is configured to obfuscate or drop a data point of the plurality of data points associated with the respective subject;
processing each data point of the plurality of data points associated with the respective subject using the respective identified handler, thereby de-identifying the plurality of data points associated with the respective subject.

20. The system of claim 19, wherein the one or more subjects comprise one or more patients, and the one or more data sets associated with the one or more subjects include medical records associated with the one or more patients.
